(19) United States
(12) Patent Application Publication
(10) Pub. No.: US 2014/0015944 A1
(43) Pub. Date: Jan. 16, 2014

(54) PART NUMBER RECOVERY SYSTEM

(71) Applicants: Thomas O'Donnell, New York, NY (US); Theodore James Mallinson, Houston, TX (US); Yakup Genc, Dayton, NJ (US); Anton Schick, Velden (DE)

(72) Inventors: Thomas O'Donnell, New York, NY (US); Theodore James Mallinson, Houston, TX (US); Yakup Genc, Dayton, NJ (US); Anton Schick, Velden (DE)

(21) Appl. No.: 13/711,782

(22) Filed: Dec. 12, 2012

Related U.S. Application Data
(60) Provisional application No. 61/569,955, filed on Dec. 13, 2011.

(51) Int. Cl. G06K 9/18

(52) U.S. Cl. CPC G06K 9/18
USPC 348/61

(57) ABSTRACT

A system for imaging characters on a surface of an object through a coating on the object includes one or more infrared (IR) radiation sources disposed to irradiate IR radiation upon a object, an IR camera disposed to received IR radiation reflected from the surface of the object, the IR camera adapted to create a digital image of the surface of the object from the received IR radiation, and a computing device in signal communication with the IR camera adapted to receive the digital image of the surface of the object from the IR camera, in which the computing device has installed therein optical character recognition (OCR) software adapted to detecting and recognizing characters imprinted upon the surface of the object.

### CROSS REFERENCE TO RELATED UNITED STATES APPLICATIONS

This application claims priority from “Part Number Recovery System”, U.S. Provisional Application No. 61/569,955 of O'Donnell, et al., filed Dec. 13, 2011, the contents of which are herein incorporated by reference in their entirety.

### TECHNICAL FIELD

This application is directed to the use of infra-red radiation to detect numbers and other symbols on coated or damaged metallic surfaces.

### DISCUSSION OF THE RELATED ART

Identification of equipment via the reading of part or serial number may be compromised if the equipment has been painted over repeatedly in order to, for example, limit damage by the elements. FIG. 1 illustrates an example of a part code 11 obscured by paint. In particular, in the oil and gas industry, much of the infrastructure is located out of doors and may be exposed to extreme conditions. A coat of primer as well as multiple topcoats of paint may be applied for protection over the part's lifetime. Regulations overseeing the safety of such equipment require periodic inspection and replacement of parts which may be at risk of failure due to aging. Determination of the age and provenance of the part depends of accurate classification, i.e., the reading of the part or serial number.

### SUMMARY

Exemplary embodiments of the invention as described herein generally include systems and methods for automatically recovering component serial numbers using near or mid-wavelength infra-red (NIR or MWIR) imaging technology to visualize surface hidden by paint. A method according to an embodiment of the invention brings value by facilitating the provenance of the part; if that cannot be determined then the part must be replaced. This act may be wasteful if the part is in fact not defective.

According to an aspect of the invention, there is provided a system for imaging characters on a surface of an object through a coating on the object, including one or more infrared (IR) radiation sources disposed to irradiate IR radiation upon a object, an IR camera disposed to received IR radiation reflected from the surface of the object, the IR camera adapted to create a digital image of the surface of the object from the received IR radiation, and a computing device in signal communication with the IR camera adapted to receive the digital image of the surface of the object from the IR camera, in which the computing device has installed therein optical character recognition (OCR) software adapted to detecting and recognizing characters imprinted upon the surface of the object.

According to a further aspect of the invention, the object is coated with a coating, the surface of the object is underneath the coating, and the IR radiation is reflected from the surface of the object after penetrating the coating.

According to a further aspect of the invention, the OCR software is adapted to detecting and recognizing characters imprinted upon the surface of the object that are hidden by the coating.

According to a further aspect of the invention, the system includes a wired connection between the IR camera and the computing device adapted to support the signal communication between the IR camera and the computing device.

According to a further aspect of the invention, the system incldues a wireless connection between the IR camera and the computing device adapted to support the signal communication between the IR camera and the computing device.

According to a further aspect of the invention, the computing device is a handheld computing device.

According to a further aspect of the invention, the computing device is a remote computing device and the signal communication is implemented via the Internet.

According to a further aspect of the invention, the IR radiation sources emit IR radiation in the wavelength range of about 3.5 μm to about 5.5 μm.

According to a further aspect of the invention, the digital image of the object surface is a still image.

According to a further aspect of the invention, the digital image of the object surface is a video image.

According to another aspect of the invention, there is provided a method for imaging characters on a surface of an object through a coating on the object, including irradiating a coated object with IR radiation, receiving IR radiation reflected from a surface of the coated object at an IR camera forming a digital image of the surface of the coated object from the received IR radiation transmitting the digital image to optical character recognition (OCR) software, and detecting characters on the surface of the object underneath the coating by the OCR software.

According to a further aspect of the invention, the method includes programming the OCR software to detect specific categories of characters in the digital image.

According to a further aspect of the invention, the specific categories include numerical digits, letters, and subsets thereof.

According to a further aspect of the invention, the method includes executing the OCR software on a computing device in signal communication with the IR camera.

According to a further aspect of the invention, the computing device is a handheld computing device.

According to a further aspect of the invention, the computing device is a remote computing device connected to the IR camera via the Internet.

According to a further aspect of the invention, the IR radiation irradiated upon the object is in the wavelength range of about 3.5 μm to about 5.5 μm.

According to a further aspect of the invention, the digital image of the object surface is a still image.

According to a further aspect of the invention, the digital image of the object surface is a video.

According to a further aspect of the invention, the digital image is transmitted to the OCR software over a wired connection.

According to a further aspect of the invention, the digital image is transmitted to the OCR software over a wireless connection.

According to a another aspect of the invention, there is provided a non-transitory program storage device readable by a computer, tangibly embodying a program of instructions executed by the computer to perform the method steps for imaging characters on a surface of an object through a coating on the object

### BRIEF DESCRIPTION OF THE DRAWINGS

FIG. 1 illustrates a part code obscured by paint, according to an embodiment of the invention.

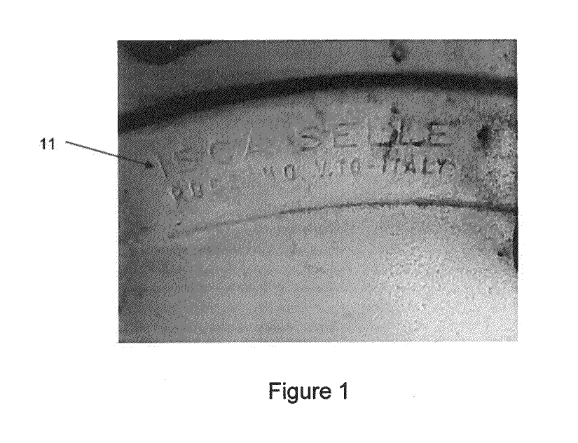

FIG. 2 illustrates the effect of coating pigments, which block visible light while transmitting IR radiation, according to an embodiment of the invention.

FIGS. 3(a)-(d) illustrate an example of using IR to image underlying corrosion on an airplane fuselage, according to an embodiment of the invention.

FIGS. 4(a)-(b) illustrate the capabilities of optical character recognition (OCR) systems, according to an embodiment of the invention.

FIG. 5 illustrates an exemplary IR imaging and OCR system according to an embodiment of the invention.

FIG. 6 is a flowchart of a part number recovery method according to an embodiment of the invention.

FIG. 7 is a block diagram of an exemplary computer system for implementing a method for recovering part numbers using NIR with OCR, according to an embodiment of the invention.

### DETAILED DESCRIPTION OF EXEMPLARY EMBODIMENTS

Exemplary embodiments of the invention as described herein generally include systems for recovering part numbers using IR with OCR, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multi-dimensional data composed of discrete image elements (e.g., pixels for 2-dimensional images and voxels for 3-dimensional images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, the methods of the inventions are not limited to such images, and can be applied to images of any dimension, e.g., a 2-dimensional picture or a 3-dimensional volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Embodiments of the invention provide a method for determining a part number in cases where it may be obscured by coatings of organic paint, i.e., paint made from organic compounds. A method according to an embodiment of the invention leverages near infrared (NIR) reflectance imaging technologies which can “see through” the layers of organic paint to determine the identifying part numbers. The NIR range of wavelengths can be defined as the range from about 0.7 μm to about 5 μm, although other classifications define the range from about 3.0 μm to about 5.0 μm as mid-wavelength IR (MWIR). However, for the purposes of this disclosure, IR wavelengths up to about 5.0 μm will be referred to as NIR. At these wavelengths, IR energy may be transmitted through the coatings while visible light is reflected or scattered. However, even if a part number is partially illuminated, it still may be difficult for a human to read. Embodiments of the invention provide the images from the near IR camera to an Optical Character Recognition (OCR) system to “read” the part number. An OCR system may perform better than a human, in particular, since it can incorporate constraints on what the allowable part numbers may be. For example, if a “4” is visible, but the OCR system knows no “4”s are possible in that position, it could interpret this as an “H”, depending on how the “4” is written. Finally, a system according to an embodiment of the invention should be portable, utilizing recent smartphone and tablet technologies. A NIR based number recovery system according to an embodiment of the invention may be part of a portable device with an attached NIR camera which may be deployed in the field.

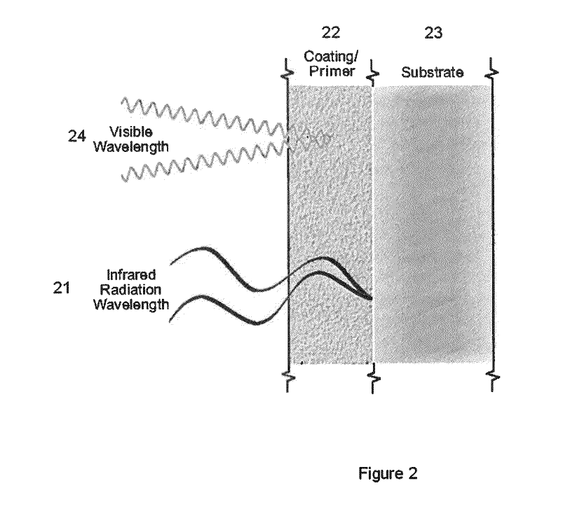

A infra-red (IR) reflectance imaging (IRRI) method according to an embodiment of the invention illuminates a surface with IR radiation that passes directly through the coating in the 3- to 5-μm range. The IR radiation reflects off the metallic substrate and passes through the coating to an IR camera, which provides an image resulting from the lower reflectance of a rough surface resulting from part serial numbers. An IRRI according to an embodiment of the invention uses IR heaters to provide the IR radiation that penetrates the coating down to a reflective, typically metallic, substrate. The IR radiation is long enough to be transmitted through the coatings, but shorter wavelength visible light is absorbed and/or scattered, effectively obscuring the underlying surface. This phenomenon is due to the longer wavelength of the IR radiation and the chemistry of the coatings. Typical coatings have an IR transmittance window between about 3.5 and 5.5 μm. The IR radiation is then reflected back from the substrate through the coating and into an IR detector. A smooth surface acts more like a mirror than does a rough surface, resulting in a higher intensity reflection. Adequate infrared (IR) transmittance is obtained with standard epoxy and polyurethane primers, and this technique can see through up to 10 mils of a standard polyurethane topcoat. FIG. 2 depicts IR radiation 21 penetrating the overlying coating/primer layer 22 covering a substrate 23, and visible light 24 being reflected from or absorbed by the coating/primer layer 22.

An IRRI method according to an embodiment of the invention can produce an image with an IR camera that uses a germanium optical lens transparent in the mid-IR range. The lens focuses an image on an indium antimonide (InSb) focal plane after passing through the filter. IR detectors using InSb have sensitive, uniform detection with a high signal-to-noise ratio. One such IR camera is the Merlin® MWIR camera, manufactured by FLIR Systems, Inc., which has a high temperature sensitivity and compressor-cooled focal plane technology. The Merlin® MWIR camera can provide a 60 Hz, 12-bit digital video output suitable for use in most personal computers.

IR illumination can reveal etched, corroded, and pitted areas under the coating as well as structural defects such as surface cracks because these areas do not reflect the IR energy as well as the smooth surface. Experiments have shown the superiority of IR illumination over visible-light illumination in differentiating a rough area from a smooth area under an organic coating.

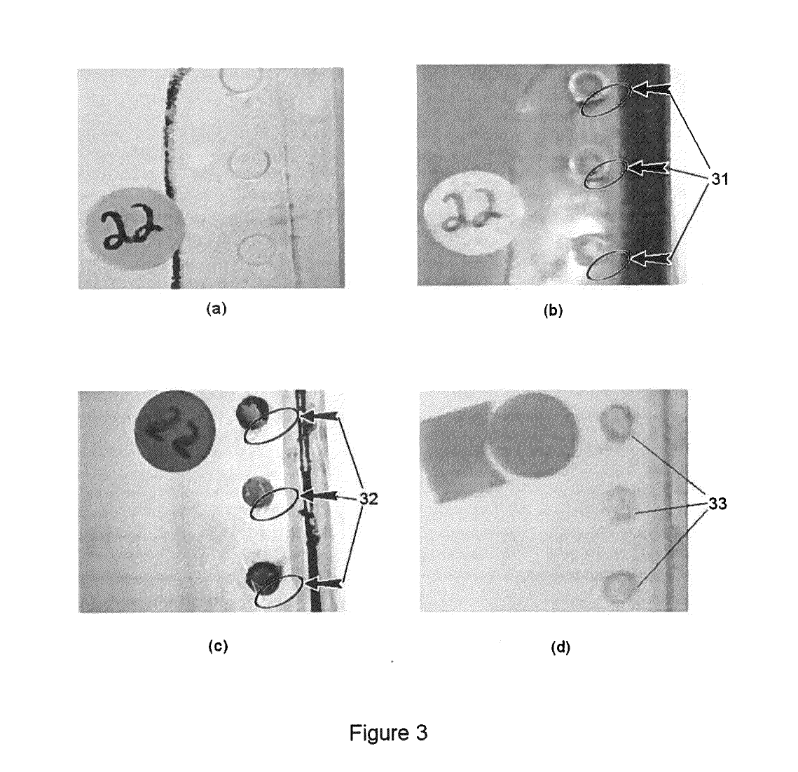

FIGS. 3(a)-(d) show an example of using near IR to recover the underlying corrosion on an airplane fuselage which goes unseen in visible light images. FIG. 3(a) depicts a visible light image of the surface. Note that no corrosion is perceptible. FIG. 3(b) depicts the same scene illuminated with NIR. In this image, the corrosion 31 surrounding the rivets is discernable. FIG. 3(c) depicts a visible light image of the fuselage with the paint layer physically removed. Again, the corrosion 32 becomes apparent. FIG. 3(d) shows how an NIR image displays the corrosion 33 in the absence of an overcoat of paint.

An IRRI system according to an embodiment of the invention is useful in the field since the IR flux can be controlled by the user to optimize the contrast ratios between rough and smooth areas under an organic coating. In addition, an IRRI system according to an embodiment of the invention can effectively image painted or coated metallic surfaces in operational environments with uncontrolled temperature fluctuations. Even at elevated temperatures, the IR illumination lamps can override the effects of blackbody radiation emitted by the metallic surface. The wattage required to change the image from blackbody-dominated to IRRI- or reflectance-dominated is low—typically about 8 W. Further, contrast will not be an issue during inspection, since controlled, angled IR sources can be adjusted to increase IR illumination and to optimize the image contrast.

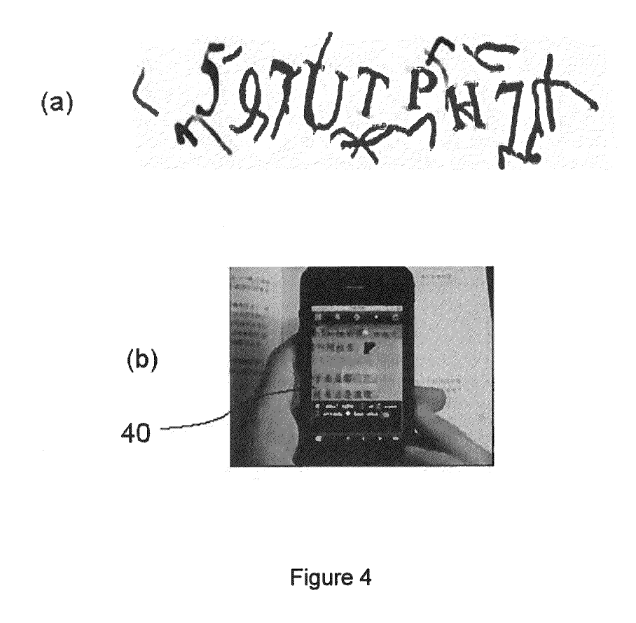

Optical Character Recognition (OCR) technologies have become extremely robust in recent years, achieving up to 98% character-by-character accuracy, to the point of becoming a commodity technology. Embodiments of the invention can utilize existing systems to interpret the output from an IR camera to correctly identify any serial or product codes. FIGS. 4(a)-(b) demonstrates the capabilities of modern optical character recognition systems. The top part of the figure, FIG. 4(a), shows that images containing significant amount of noise are still readable, while the bottom part, FIG. 4(b), shows that even Chinese characters 40 do not pose a problem for these systems.

Similarly, handheld devices with significant computing power are becoming increasingly available. Embodiments of the invention can provide w wired or wireless connection between the IR camera and the handheld device to transmit the video output of the IR camera to OCR software executing on the handheld device, which can present a raw, unprocessed image along with recognized characters to the a user for identification. In addition, alternative embodiments can transmit the video output of the IR camera to cloud-based OCR applications for processing.

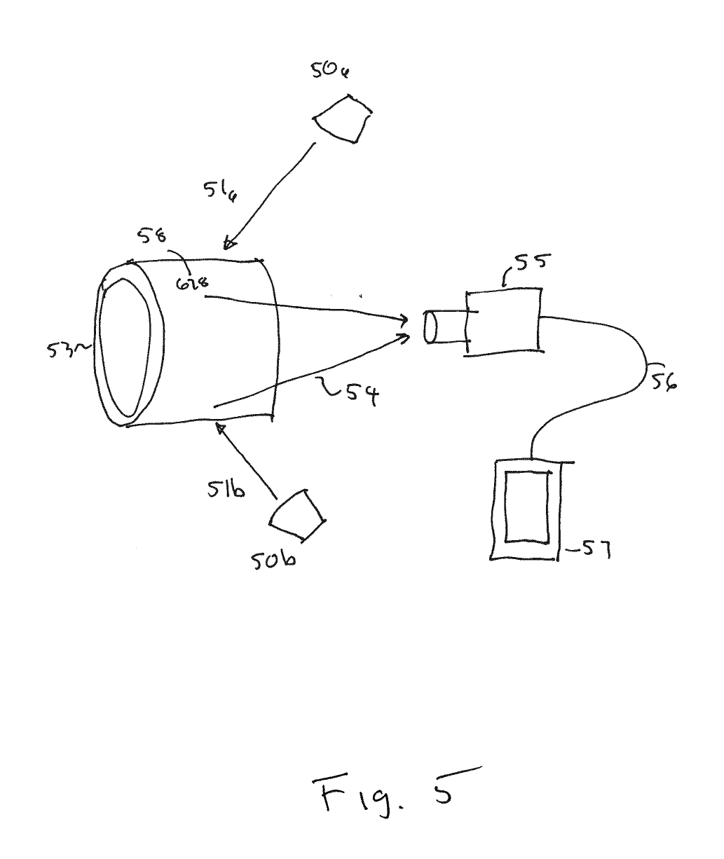

An exemplary IR imaging and OCR system according to an embodiment of the invention is shown in FIG. 5. Referring now to the figure, and exemplary system includes one or more IR light sources 50a, 50b that can irradiate IR light 51a, 51b upon an object 53. Object 53 has imprinted thereon a part number 58 which may be covered by paint. IR light 54 is reflected from the object 53 and captured by an IR camera 55, which creates an image of the object 53. A connection 56 between the camera 55 and a portable computing device 57 enables the IR camera 55 to transmit the image to the portable computing device 57. The connection 106 can be a wired connection or a wireless connection. The portable computing device 57 can be any device as is known in the art, such as a laptop computer, a tablet computer, a smartphone, etc, and includes OCR software that analyses the IR image for character content. In some embodiments, the IR camera 55 has an Internet connection to a cloud based service that executes OCR software that analyzes the images, instead of using a portable computing device. The Internet connection may be a wired or a wireless connection.

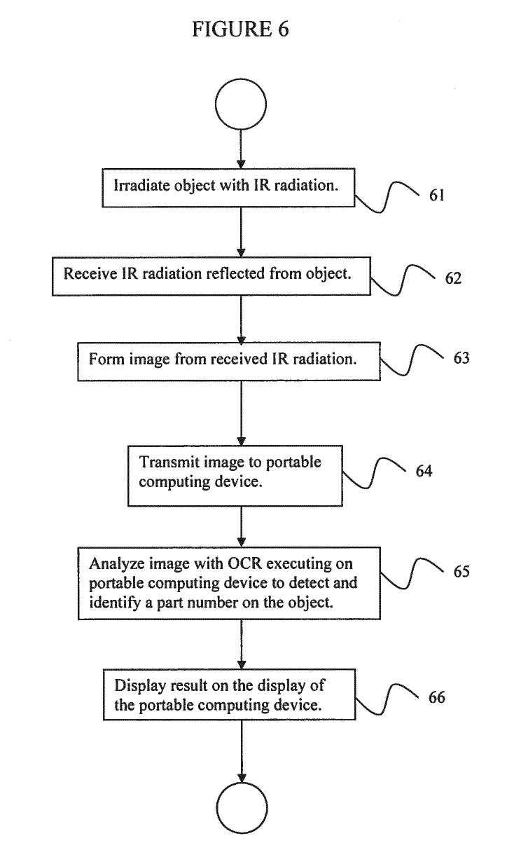

FIG. 6 is a flowchart of a part number recovery method according to an embodiment of the invention. In a method according to an embodiment of the invention, at step 61, the object 53 is irradiated with IR light 51a, 51b of an appropriate wavelength emitted by the IR light sources 50a, 50b. The IR camera 55 receives the IR light 54 reflected from the object 53 at step 62 to form a video or still image at step 63. The IR camera 55 then transmits the image data to the portable computing device 57 at step 64, where the image data is received by OCR software being executed by the portable computing device 57. The OCR software then analyzes the image data at step 65 to identify any characters present in the image data, and displays the results in the display of the portable computing device 57 at step 66. In particular, the OCR software will be able to detect and recognize the part number 58 on the object 53. In some embodiments, the OCR software can be programmed with characters that should be present on the object, such as numbers, letters or subsets thereof, to make the recognition process more efficient.

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

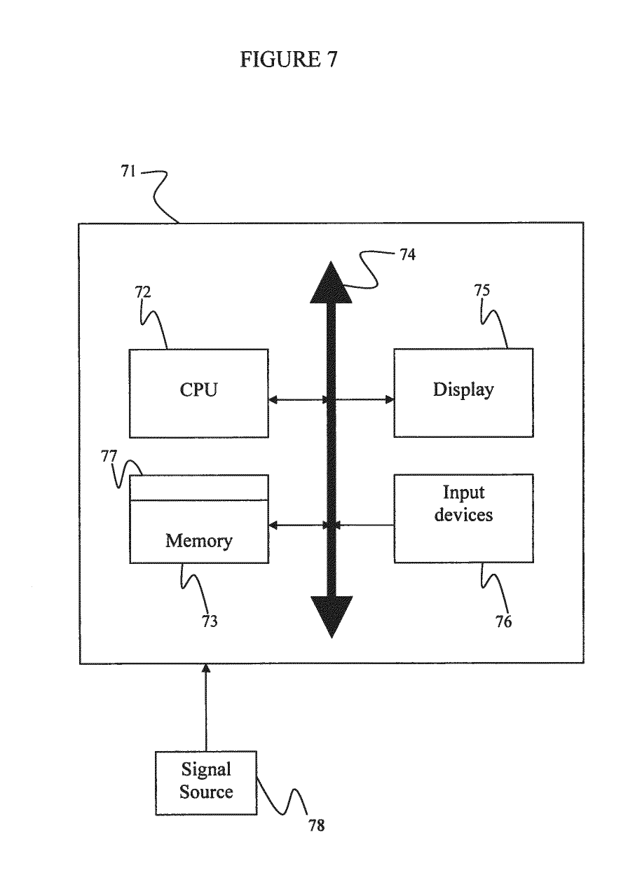

FIG. 7 is a block diagram of an exemplary computer system for implementing a method for recovering part numbers using NIR with OCR according to an embodiment of the invention. Referring now to FIG. 7, a computer system 71 for implementing the present invention can comprise, inter alia, a central processing unit (CPU) 72, a memory 73 and an input/output (I/O) interface 74. The computer system 71 is generally coupled through the I/O interface 74 to a display 75 and various input devices 76 such as a mouse and a keyboard. The support circuits can include circuits such as cache, power supplies, clock circuits, and a communication bus. The memory 73 can include random access memory (RAM), read only memory (ROM), disk drive, tape drive, etc., or a combinations thereof. The present invention can be implemented as a routine 77 that is stored in memory 73 and executed by the CPU 72 to process the signal from the signal source 78. As such, the computer system 71 is a general purpose computer system that becomes a specific purpose computer system when executing the routine 77 of the present invention.

The computer system 71 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. A system for imaging characters on a surface of an object through a coating on the object, comprising:
one or more infrared (IR) radiation sources disposed to irradiate IR radiation upon a object;
an IR camera disposed to received IR radiation reflected from the surface of said object, said IR camera adapted to create a digital image of the surface of said object from the received IR radiation; and
a computing device in signal communication with said IR camera adapted to receive the digital image of the surface of said object from said IR camera, wherein said computing device has installed therein optical character recognition (OCR) software adapted to detecting and recognizing characters imprinted upon the surface of said object.

2. The system of claim 1, wherein said object is coated with a coating, the surface of said object is underneath the coating, and the IR radiation is reflected from the surface of said object after penetrating said coating.

3. The system of claim 2, wherein the OCR software is adapted to detecting and recognizing characters imprinted upon the surface of said object that are hidden by the coating.

4. The system of claim 1, further comprising a wired connection between the IR camera and the computing device adapted to support the signal communication between the IR camera and the computing device.

5. The system of claim 1, further comprising a wireless connection between the IR camera and the computing device adapted to support the signal communication between the IR camera and the computing device.

6. The system of claim 1, wherein the computing device is a handheld computing device.

7. The system of claim 1, wherein the computing device is a remote computing device wherein the signal communication is implemented via the Internet.

8. The system of claim 1, wherein the IR radiation sources emit IR radiation in the wavelength range of about 3.5 μm to about 5.5 μm.

9. The system of claim 1, wherein the digital image of the object surface is a still image.

10. The system of claim 1, wherein the digital image of the object surface is a video image.

11. A method for imaging characters on a surface of an object through a coating on the object, comprising:
irradiating a coated object with IR radiation;
receiving IR radiation reflected from a surface of said coated object at an IR camera;
forming a digital image of the surface of said coated object from the received IR radiation;
transmitting said digital image to optical character recognition (OCR) software; and
detecting characters on the surface of said object underneath said coating by said OCR software.

12. The method of claim 11, further comprising programming said OCR software to detect specific categories of characters in said digital image.

13. The method of claim 12, wherein said specific categories include numerical digits, letters, and subsets thereof.

14. The method of claim 11, further comprising executing said OCR software on a computing device in signal communication with said IR camera.

15. The method of claim 14, wherein said computing device is a handheld computing device.

16. The method of claim 14, wherein said computing device is a remote computing device connected to said IR camera via the Internet.

17. The method of claim 11, wherein the IR radiation irradiated upon the object is in the wavelength range of about 3.5 μm to about 5.5 μm.

18. The method of claim 11, wherein the digital image of the object surface is a still image.

19. The method of claim 11, wherein the digital image of the object surface is a video.

20. The method of claim 11, wherein said digital image is transmitted to said OCR software over a wired connection.

21. The method of claim 11, wherein said digital image is transmitted to said OCR software over a wireless connection.

22. A non-transitory program storage device readable by a computer, tangibly embodying a program of instructions executed by the computer to perform the method steps for imaging characters on a surface of an object through a coating on the object, the method comprising the steps of:
irradiating a coated object with IR radiation;
receiving IR radiation reflected from a surface of said coated object at an IR camera;
forming a digital image of the surface of said coated object from the received IR radiation;
transmitting said digital image to optical character recognition (OCR) software; and
detecting characters on the surface of said object underneath said coating by said OCR software.

23. The computer readable program storage device of claim 22, the method further comprising programming said OCR software to detect specific categories of characters in said digital image.

24. The computer readable program storage device of claim 23, wherein said specific categories include numerical digits, letters, and subsets thereof.
